(19) United States
(12) Patent Application Publication
(10) Pub. No.: US 2021/0117484 A1
(43) Pub. Date: Apr. 22, 2021

(54) WEBPAGE TEMPLATE GENERATION

(71) Applicant: salesforce.com, inc., San Francisco, CA (US)

(72) Inventor: Michael Sollami, Cambridge, MA (US)

(21) Appl. No.: 16/658,322

(22) Filed: Oct. 21, 2019

(51) Int. Cl. G06F 16/958; G06F 17/24; G06F 16/957; G06N 3/08; G06K 9/62

(52) U.S. Cl. CPC G06F 16/958; G06F 17/248; G06K 9/6256; G06N 3/084; G06F 16/9577

(57) ABSTRACT

Systems, device and techniques are disclosed for webpage template generation. Scores may be generated for images of webpages. A generative adversarial network may be trained using the images of the webpages and the scores generated for the images of the webpages. Images may be generated using the trained generative adversarial network. A webpage template may be generated from an image generated using the trained generative adversarial network. The webpage template may include one or both of HTML code and a wireframe template.

### BACKGROUND

Designing websites may be slow and expensive when done by a web designer. This may make it difficult to have large numbers of websites designed in short periods of time while having those websites adhere to graphical design principles that result in websites that are both usable and have high aesthetic value.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system for webpage template generation according to an implementation of the disclosed subject matter.

FIG. 2 shows an example arrangement for webpage template generation according to an implementation of the disclosed subject matter.

FIG. 3A shows an example arrangement for webpage template generation according to an implementation of the disclosed subject matter.

FIG. 3B shows an example arrangement for webpage template generation according to an implementation of the disclosed subject matter.

FIG. 4A shows an example arrangement for webpage template generation according to an implementation of the disclosed subject matter.

FIG. 4B shows an example arrangement for webpage template generation according to an implementation of the disclosed subject matter.

FIG. 4C shows an example arrangement for webpage template generation according to an implementation of the disclosed subject matter.

FIG. 5 shows an example procedure suitable for webpage template generation according to an implementation of the disclosed subject matter.

FIG. 6 shows an example procedure suitable for webpage template generation according to an implementation of the disclosed subject matter.

FIG. 7 shows an example procedure suitable for webpage template generation according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

Techniques disclosed herein enable webpage template generation, which may allow for the generation of webpage templates that may be used to create webpages for a website using a generative adversarial network. Images of existing webpages may be scored. The scored images may be used as part of a training data set for generative adversarial network (GAN). The GAN may be trained using the training data set. The GAN, after being trained, may be used to generate images which may appear to be webpages. The generated images may be converted into HTML and into wireframe templates which may be stored as webpage templates. The images of existing webpages used in the training data set may be taken from the same website so that the trained GAN may generate images that appear to be variations of webpages from that website.

Images of webpages from existing websites may be scored. The images of webpages may be from any suitable websites. For example, the images of webpages may be taken from websites that are considered to be well-designed, for example, are ranked highly on websites that review or rank websites on design and aesthetic criteria. Images may also be taken of webpages from websites considered to be normal, for example, websites that are not ranked highly, or at all, on websites that review or rank websites on design and aesthetic criteria. The webpage images may be obtained in any suitable manner. For example, an automated scraper may be used to obtain the images of webpages from websites through, for example screen captures or other scraping techniques. Heuristic scoring may be used to assign scores to the images of the webpages. The heuristics may be any suitable heuristics which may be generated and applied in any suitable manner. For example, the heuristics may be based on the grading of a sample set of webpages by professional web designers or on eye tracking and brain scan data gathered from showing images of websites to people. The heuristics may, for example, assign higher scores to images of webpages that are well-designed, adhere to graphical design principles, or otherwise include properties considered desirable in webpages. Other suitable forms of scoring my also be used to score the images of webpages. For example, a machine learning model, such as a neural network, that has been trained to score images may be used to score the images of webpages. The scored images of existing webpages may be used to create a training data set for a GAN.

The scored images of webpages in the training data set may be used to train the GAN. The images of webpages may be input to a discriminator network of a GAN. The discriminator network may be, for example, a convolutional neural network with any suitable number of layers and weights connected in any suitable manner. For each image of a webpage from the training data set input to the discriminator network, the discriminator network may output an indication of whether the image is of a webpage with high score, for example, a well-designed webpage, or a webpage with a not a high score, for example, a webpage from a normal website that may be less well-designed. Errors in the indications output by the discriminator network, determined by comparing the indications output by the discriminator network based on the input images of webpages to the scores from the training data set for the input images of webpages, may be used to adjust the discriminator network. For example, backpropagation may be used to adjust the weights of the discriminator network, training the discriminator network based on errors made by the discriminator network. The discriminator network may be trained for any suitable length of time, using any suitable number of the images of websites from the training data set.

After the discriminator network of the GAN has been trained for a set length of time or on a set number of images of webpages from the training data set, a generator network of the GAN may be trained. The generator network of the GAN may be, for example, a neural network that may include any suitable number of layers and weights connected in any suitable manner. A random input may be input to the generator network. The random input may be, for example, a vector with any suitable number of elements set to random or pseudorandom values. The generator network may output an image. The image output by the generator network may be input to the discriminator network, which may output an indication of whether the image appears to be a webpage with a high score or a webpage with a not high score. When the discriminator network indicates that the image appears to be a website with a not high score, the weights of the generator network may be adjusted, for example, through backpropagation, training the generator network. The generator network may be trained based on a loss function for the generator network. The generator network may be trained for any suitable length of time, using any suitable number of random inputs.

After the generator network of the GAN has been trained for a set length of time or been given a set number of random inputs, the discriminator network may be trained again. The discriminator network may be trained using the images of webpages from the training data set. Images generated by the generator network during the training of the generator network may also be added to the training data set. The images generated by the generator network may be scored in the same manner that the images of the webpages were scored, and the scored images from the generator network may be added to the training data set. The discriminator network may be trained for any suitable length of time, using any suitable number of the images of webpages, and images from the generator network, from the training data set, after which the generator network may be trained again for any suitable length of time, using any suitable number of random inputs. Training may alternate between the discriminator network and the generator network, and may continue for any suitable period of time. For example, the discriminator network and generator network may be trained until the discriminator network reaches a threshold level of accuracy on the training data set and a threshold percentage of images output by the generator network are indicated by the discriminator network as being images of webpages with high scores.

The trained GAN may be used to generate images. The trained GAN may input any number of random inputs to the generator network. Images generated by the generator network may be input to the discriminator network. Images that the discriminator network indicates are images of websites with high scores may be output by the GAN, while images that the discriminator network indicates are images of webpages with not high scores may be discarded.

Images output by the GAN may be converted into HTML code and wireframe templates. For example, an image output by the GAN may be input to an image-to-code system that may convert the image into HTML code. The HTML code may then be used to generate a wireframe template. In some implementations, an image output by the GAN may be input to a system that may generate wireframe templates from images. The wireframe template may then be input to an image-to-code system that may convert the wireframe template to HTML code. In some implementations, the image output by the GAN may be used to generate both the HTML code and the wireframe template independently. The wireframe template and HTML code generated from an image output by the GAN may be a webpage template that may allow the creation of a webpage with the appearance of the image, which may include, for example, having structures, such as sections, from the image.

In some implementations, the images of webpages in the training data set for the GAN may be taken from the same website. The wireframe templates and HTML code generated with images output from a GAN trained with a training data set that includes images of webpages taken from the same website may be webpage templates for webpages that are variants of the webpages from that website. The variant webpages may be geometrically similar to the webpages of the website whose images form the training data set.

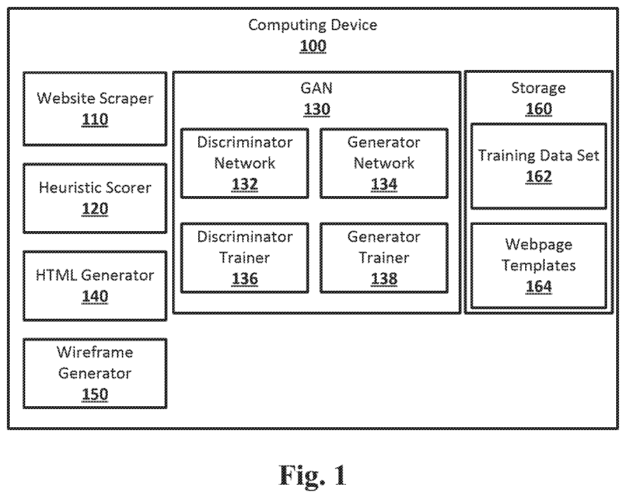

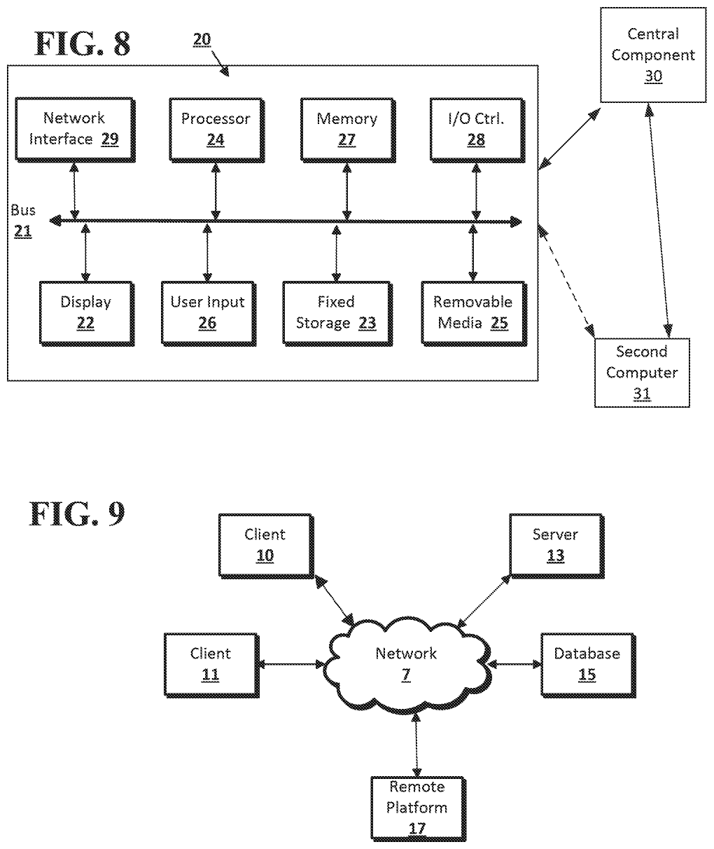

FIG. 1 shows an example system for webpage template generation according to an implementation of the disclosed subject matter. A computing device 100 may be any suitable computing device, such as, for example, a computer 20 as described in FIG. 8, or component thereof, for webpage template generation. The computing device 100 may include a website scraper 110, heuristic scorer 120, generative adversarial network (GAN) 130, HTML generator 140, wireframe generator 150, and storage 160. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs).

The website scraper 110 may be any suitable combination of hardware and software of the computing device 100 for capturing images of webpages from websites. The website scraper 110 may, for example, access the Internet through any suitable network connection, access websites, and capture images of webpages from the websites. The images may be captured at any suitable resolution and may show the webpages displayed in any suitable aspect ratio. The website scraper 110 may, for example, use any suitable screen capture techniques to capture an image of a webpage. Images of webpages captured by the website scraper 110 may be stored in the storage 160 as part of a training data set 162. The images of webpages may be stored in any suitable manner. For example, the images may be stored in a file format for raw or compressed images, or may be pre-processed into a feature vector format that may be suitable for input to a machine learning model such a neural network.

The heuristic scorer 120 may be any suitable combination of hardware and software of the computing device 100 for scoring images of webpages. The heuristic scorer 120 may use any suitable image processing techniques to assess an image of a webpage, for example, as obtained by the website scraper 110, and any suitable heuristics to assign a score to the image of the webpage. The heuristics used by the heuristic scorer 120 may be from any suitable source. For example, the heuristics may be based on graphical design principles used by web designers or other professional graphic designers, and may assign higher scores to image of webpages that adhere to the graphical design principles that are considered to produce webpages and websites of higher aesthetic value. The heuristic scorer 120 may also be based on, for example, a machine learning model that has been previously trained to evaluate images generally, or data gathered through eye tracking models of subjects looking at images of webpages. The heuristics used by the heuristic scorer 120 may be adjusted based on desired properties of the webpages output by the GAN 130. For example, if it is desired that the output webpages have fewer sections, the heuristics of the heuristic scorer 120 may be adjusted to give higher scores to images of webpages that have fewer sections. Scores assigned to images of webpages by the heuristic scorer 120 may be stored in the storage 160 as part of the training data set 162 along with the image of a webpage the score was assigned to.

The GAN 130 may be any suitable combination of hardware and software of the computing device 100 for implementing a generative adversarial network. The GAN 130 may include, for example, a discriminator network 132, a generator network 143, a discriminator trainer 136, and a generator trainer 138. The discriminator network 132 of the GAN 130 may be a machine learning model, such as a convolutional neural network with a any suitable number of layers connected in any suitable manner by any suitable number of weights. The discriminator network 132 may be trained using images of webpages from the training data set 162 to identify images of webpages that were, or would be, assigned high scores by the heuristic scorer 120. During training of the discriminator network 132, the discriminator trainer 136 may determine errors made by the discriminator network 132 and adjust the discriminator network 132 through, for example, backpropagation to adjust the weights of the neural network of the discriminator network 132. The generator network 134 may be a machine learning model, such as a neural network, that may be trained to output images of webpages that may be considered by the discriminator network 132 to be images of webpages that were, or would be, assigned high scores from the heuristic scorer 120. During training of the generator network 134, the discriminator network 132 may be used to determine when the images output by the generator network 124 are not considered by the discriminator network 132 to be images of websites assigned high scores, and the generator trainer 138 may adjust the generator network 134 through, for example, backpropagation.

The HTML generator 140 may be any suitable combination of hardware and software of the computing device 100 for generating HTML code from an image or wireframe template. The HTML generator 140 may be any suitable image-to-code system that may accept as input an image or wireframe and may output HTML code that may be rendered by a suitable renderer into a webpage with the appearance of the image or wireframe. HTML code generated by the HTML generator 140 may be stored with the webpage templates 164.

The wireframe generator 150 may be any suitable combination of hardware and software of the computing device 100 for generating a wireframe template from an image or from HTML code. The wireframe generator 150 may accept as input an image or HTML code, and may output a wireframe template that may have the appearance of the image or of a webpage rendered using the HTML code. The wireframe template may, for example, include outlines of the gross structures of the image or the webpage rendered using the HTML code. Wireframe templates generated by the wireframe generator 150 may be stored with the webpage templates 164.

The storage 160 may be any suitable combination of hardware and software for storing data. The storage 160 may include any suitable combination of volatile and non-volatile storage hardware, and may include components of the computing device 100 and hardware accessible to the computing device 100, for example, through wired and wireless direct or network connections. The storage 160 may store the training data set 162, and the webpage templates 164. The webpage templates 164 may be HTML code and wireframe templates that may serve as webpage templates that may be used to create webpages.

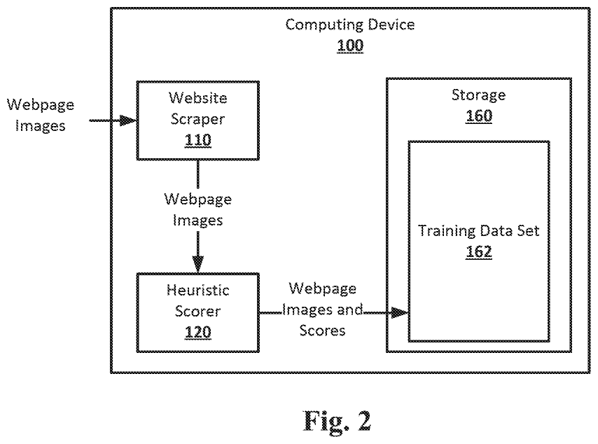

FIG. 2 shows an example arrangement for webpage template generation according to an implementation of the disclosed subject matter. The website scraper 110 may receive webpage images. The webpage images may be images of existing websites which may be obtained by the website scraper 110 in any suitable manner. For example, the website scraper 110 may visit websites on the Internet and capture images of webpages from the websites, for example, through screen capture techniques or in any other suitable manner. The webpage images may be obtained at any suitable resolution and any suitable aspect ratio, and images of the same webpage may be obtained with the webpage displayed at different aspect ratios. Images of a number of different webpages of the same website may be captured. The website scraper 110 may determine which web sites to visit and obtain webpages images from in any suitable manner. For example, the website scraper 110 may be provided with a list of websites, for example, websites that are considered to have webpages that are well-designed and that may be given high scores by the heuristic scorer 120. The website scraper 110 may also visit and capture images of webpages from websites that may be considered normal, for example, websites with webpages that may not be given high scores by the heuristic scorer 120.

The webpage images received at the website scraper 110 may be input to the heuristic scorer 120. The heuristic scorer 120 may score each of the webpage images. The scores assigned to webpages may be on any suitable scale, such as, for example, a 0 to 100 scale, with any suitable interpretation. For example, 0 may be the lowest score and 100 may be the highest score. For example, webpage images that adhere to graphical design principals embodied in the heuristics of the heuristic scorer 120 may receive higher scores.

The webpage images from the website scraper 110 may be stored along with their scores from the heuristic scorer 120 in the training data set 162. Any suitable number of webpage images with scores may be stored in the training data set 162. For example, the website scraper 110 may capture images of webpages from thousands of websites, and the images may be scored by the heuristic scorer 120 and stored in the training data set 162. In some implementations, the images in the training data set 162 of highly scored webpages may all have been obtained from the same website, while the images of webpages with lower scores may be from a variety of different websites. The images of webpages in the training data set 162 may be stored in any suitable format, including, for example, in an image file format, or in a feature vector format suitable for input to machine learning models, such as a neural network.

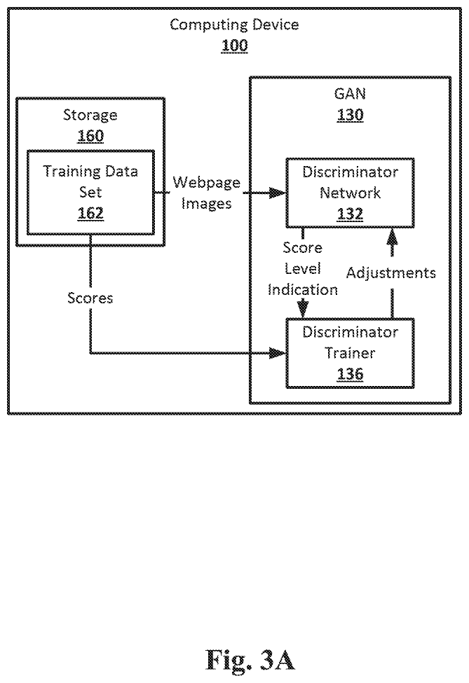

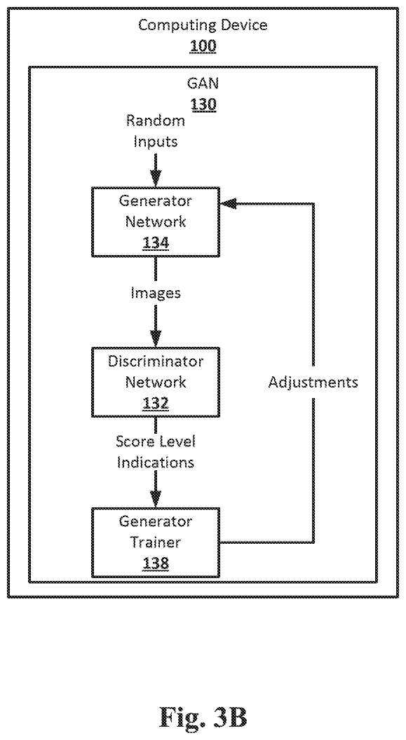

FIG. 3A shows an example arrangement for webpage template generation according to an implementation of the disclosed subject matter. Webpage images from the training data set 162 may be input to the discriminator network 132 of the GAN 130. The webpage images may be converted into a feature vector format before being input to the discriminator network 132. For each input webpage image, the discriminator network 132 may output a score level indication. The score level indication may be an indication of the score that the discriminator network 132 estimates was assigned, or would be assigned, to the webpage image by the heuristic scorer 120. The score level indication may be, for example, a binary output, indicating an estimation of either a high score or a not high score. The score level indication may be output from the discriminator network 132 to the discriminator trainer 136. The discriminator trainer 136 may also receive the scores assigned to the webpage images by the heuristic scorer 120 from the training data set 162.

The discriminator may compare the score level indication received from the discriminator network 132 based on the input of a webpage image from the training data set 162 to the score assigned to that webpage image as received from the training data set 162 to determine the correctness of the score level indication. For example, if the discriminator network 132 outputs a score level indication of a high score based on the input of a webpage image, and the score assigned to the webpage image by the heuristic scorer 120 is high, for example, 95 out of 100, then the discriminator trainer 136 may determine that the score level indication output by the discriminator network 132 was correct. Similarly, a score level indication of a not high score may be determined to be correct when the score assigned to the webpage image by the heuristic image 120 is not high. The discriminator trainer 136 may be configured to use any suitable threshold when determining whether a score assigned to a webpage image by the heuristic trainer 120 is or is not a high score. When the score level indication output by discriminator network 132 for a webpage image is determined to be correct, the discriminator 136 may not make any adjustments to the discriminator network 132. If, for example, the discriminator network 132 output a score level indication of a not high score based on the input of a webpage image, and the score assigned to the webpage image by the heuristic scorer 120 is high, for example, 95 out of 100, then the discriminator trainer 136 may determine that the score level indication output by the discriminator network 132 was incorrect. When the score level indication output by discriminator network 132 for a webpage image is determined to be incorrect, the discriminator 136 may determine and make adjustments to the discriminator network 132, for example, adjusting weights of the discriminator network 132 through backpropagation.

Any number of webpage images from the training data set 162 may be input to the discriminator network 132 of the GAN 130, over any suitable period of time, to train the discriminator network 132 during a training cycle. For example, the discriminator network 132 may be trained for a set period of time, such as for one hour, regardless of the number of webpage images the discriminator network 132 is able to generate score level indications for over that time period, and the training cycle for the discriminator network 132 may end at the end of the period of time.

FIG. 3B shows an example arrangement for webpage template generation according to an implementation of the disclosed subject matter. After the discriminator network 132 has been trained, for example, for any suitable period of time or on some number of webpage images from the training data set 162, completing a training cycle, the generator network 134 may be trained. Random inputs may be input to the generator network 134, which may output images based on the random input. The random inputs may be, for example, vectors with any suitable number of elements with random or pseudorandom values. The images may be output in any suitable format, including, for example, in a feature vector format suitable for input to the discriminator network 132. The images output by the generator network 134 may be input to the discriminator network 132. The discriminator network 132 may generate score level indications for the input images in the same manner that the discriminator network 132 generated score level indications for the webpage images from the training data set 162. The score level indications generated based on the input images may be input to the generator trainer 138. The generator trainer 138 may determine whether the score level indication for an input image indicates that the discriminator network 132 estimated that the input image was a webpage image that was assigned a high score from the heuristic scorer 120 or a webpage image that was assigned a not high score. If the score level indication for an input image is an indication of a high score, the generator trainer 138 may make no adjustments to the generator network 134. If the score level indication for an input image is an indication of a not high score, the generator trainer 138 may determine and apply adjustments to the generator network 134, for example, adjusting weights of the generator network 134 through backpropagation. The generator trainer 138 may determine the adjustment to the generator network 134 through, for example, a loss function for the generation network 134.

Any number of random inputs may be input to the generator network 134 of the GAN 130, over any suitable period of time, to train the generator network 134 during a training cycle for the generator network 134. For example, the generator network 134 may be trained for a set period of time, such as for one hour, regardless of the number of random inputs the generator network 134 is able to generate images for over that time period, with the training cycle for the generator network 134 ending after the end of the period of time.

After the generator network 134 has been trained, for example, for any suitable period of time or on some number of random inputs, the discriminator network 132 may be trained again. Images output by the generator network 134 during the training of the generator network 134 may be added to the training data set 162 to be used during the next round of training the discriminator network 132. For example, an image output by the generator network 134 that is estimated by the discriminator network 132 to be an image of a webpage that received a high score from the heuristic scorer 120 may be input to the heuristic scorer 120 to receive its actual score, and then may be added to the training data set 162.

A training cycle for the GAN 130 may alternate between training cycles for the discriminator network 132 and the generator network 134 any suitable number of times, and the end of the training cycle for the GAN 130 may be determined in any suitable manner. For example, training may continue until the discriminator network 132 achieves a threshold level of accuracy in its score level indications for input webpage images from the training data set 162 and a threshold percentage of images output by the generator network 134 are estimated by the discriminator network 132 to be images of webpages that would be assigned high scores.

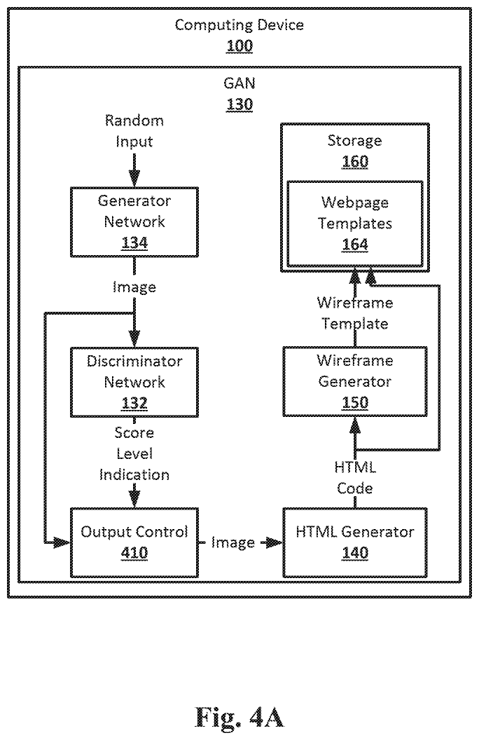

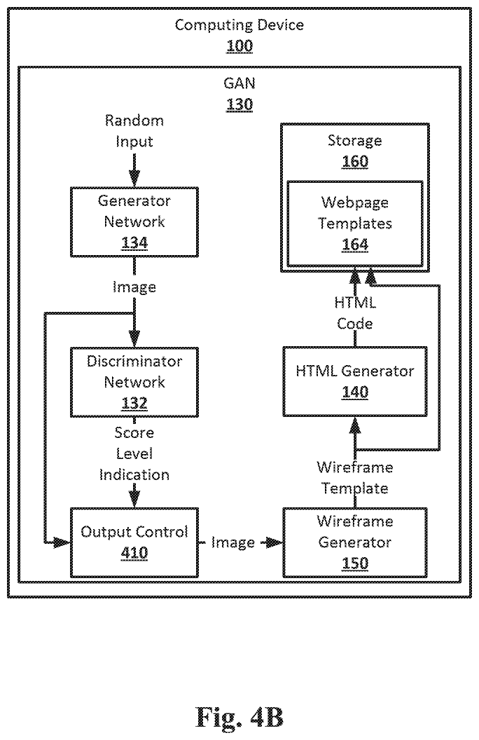

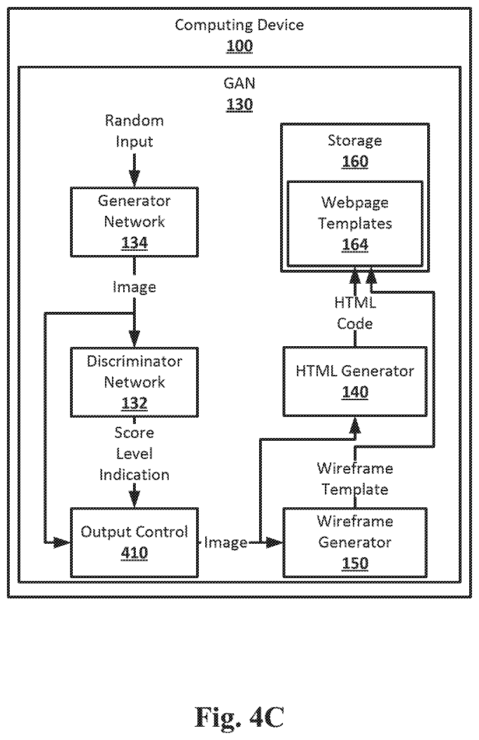

FIG. 4A shows an example arrangement for webpage template generation according to an implementation of the disclosed subject matter. The GAN 130 may be used to generate images. The images output by the GAN 130 may be images that include features similar to the images of webpages assigned high scores by the heuristic scorer 120. A random input may be input to the generator network 134. The generator network 134 may output an image to the discriminator network 132. The discriminator network 132 may output a score level indication to an output control 410. The output control 410 may control the output of the GAN 130 by determining if a score level indication output by the discriminator network 132 based on an image generated by the generator network 134 indicates that the image is an image of webpage that would be assigned a high score by the heuristic scorer 120. The output control 410 may allow an image generated by the generator network 134 to be output from the GAN 130 when the score level indication is an indication that the image is an image of webpage that would be assigned a high score by the heuristic scorer 120. Otherwise, the image may be discarded. The output control 410 may ensure that images output from the GAN 130 may have features associated with well-designed webpages that may be scored highly by the heuristic scorer 120. In some implementations, the GAN 130 may not use the discriminator network 132 and the output control 410 when outputting images, and all images generated by the generator network 134 may be output by the GAN 130. Images may be output from the GAN 130 in any suitable format, including, for example, in any suitable image file format.

Images output from the GAN 130 may be input to the HTML generator 140. The HTML generator 140 may convert the image to HTML code. The HTML code output by the HTML generator 140 may render a webpage based on the image when input to any suitable HTML renderer. The HTML code may be stored with the webpage templates 164 in the storage 160.

HTML code output form the HTML generator 140 may be input to the wireframe generator 150. The wireframe generator 150 may generate a wireframe template from the HTML code. The wireframe template may be in any suitable format, and may be, for example, a vector-based wireframe of the webpage that an HTML renderer may render with the HTML code. The wireframe template may be stored with the HTML code used to generate it with the webpage templates 164. The HTML code and wireframe template generated from an image output by the GAN 130 may be webpage template.

FIG. 4B shows an example arrangement for webpage template generation according to an implementation of the disclosed subject matter. In some implementations, the GAN 130 may output images to the wireframe generator 150. The wireframe generator 150 may output wireframe templates to the HTML generator 140, which may generate HTML code based on the wireframe template.

FIG. 4C shows an example arrangement for webpage template generation according to an implementation of the disclosed subject matter. In some implementations, the GAN 130 may output images to both the HTML generator 140 and the wireframe generator 150. The HTML generator 140 may generate HTML code based on the images, and wireframe generator 150 may generate wireframe templates based on the images.

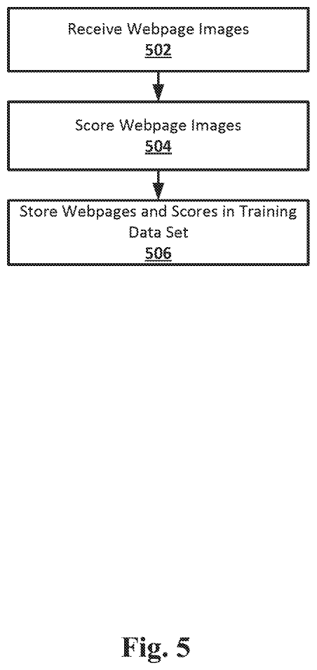

FIG. 5 shows an example procedure suitable for webpage template generation according to an implementation of the disclosed subject matter. At 502, webpage images may be received. For example, the website scraper 110 may access websites on the Internet and obtain images of webpages from the websites. The webpage images may be obtained in any suitable manner, such as, for example, through screen capture or other image scraping techniques. The websites accessed by the website scraper 110 and from which webpage images may be obtained may be, for example, websites from a list of websites that are considered to be well-designed. The website scraper 110 may also visit and obtain webpage images from, for example, a random of sampling of websites.

At 502, webpage images may be scored. For example, webpage images obtained by the website scraper 110 may be input to the heuristic scorer 120, which may assign scores to the webpages. The heuristic scorer 120 may use any suitable heuristics, and may give high scores to webpages that adhere to graphical design principals for well-designed webpages, as determined by, for example, professional web designers, or based on, for example, machine learning model evaluation of webpages, eye-tracking and brain scan data from people viewing webpages, or any other suitable criteria.

At 504, the webpages images and scores may be stored in a training data set. For example, the webpage images, with their scores assigned by the heuristic scorer 120, may be stored in the training data set 162 in the storage 160.

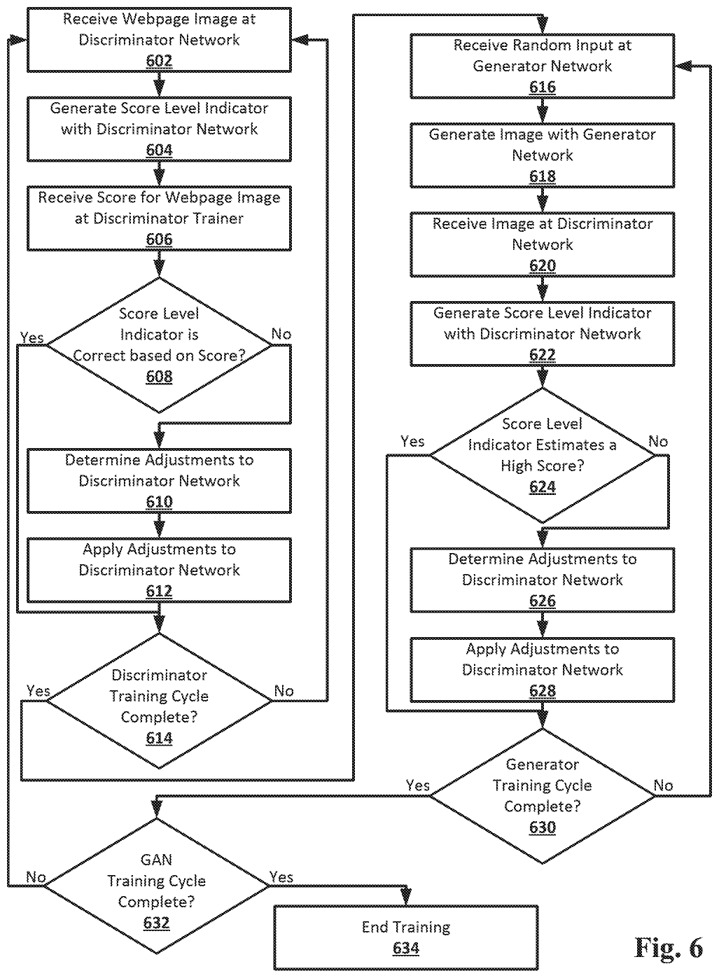

FIG. 6 shows an example procedure suitable for webpage template generation according to an implementation of the disclosed subject matter. At 602, a webpage image may be received at a discriminator network. For example, the discriminator network 132 of the GAN 130 may receive a webpage image from the training data set 162. The webpage image may be received in any suitable format, such as, for example, as a feature vector.

At 604, a score level indicator may be generated with the discriminator network. For example, the discriminator network 132 may generate a score level indicator based on the webpage image input to the discriminator network 132. The score level indicator may be, for example, a binary indicator, and may be an estimate of whether the webpage image was, or would be, assigned a high score or not a high score by the heuristic scorer 120.

At 606, a score for the webpage image may be received at a discriminator trainer. For example, the score that was assigned to the webpage image received at the GAN 130 may be received at the discriminator trainer 136 of the GAN 130 from the training data set 162.

At 608, if the score level indicator is correct based on the score for the webpage image, flow may proceed to 614. Otherwise, flow may proceed to 610. The score level indicator may be determined to be correct by, for example, the discriminator trainer 136 comparing the score level indicator to the score for the webpage image. If the score level indicator indicates an estimate of a high score and the score for the webpage image is a high score, the score level indicator may be correct. If the score level indicator indicates an estimate of not a high score and the score for the webpage image is a high score, the score level indicator may not be correct.

At 610, adjustments may be determined for the discriminator network. For example, the discriminator trainer 136 may determine adjustments to be made to the discriminator network 132 based on the score level indicator output by the discriminator network 132 being incorrect. The adjustments may be, for example, adjustments to the weights of the discriminator network 132.

At 612, adjustments may be applied to the discriminator network. For example, the discriminator trainer 136 may apply the determined adjustments the discriminator network 132. For example, the discriminator trainer 136 may apply the determined adjustments through backpropagation.

At 614, if the training cycle for the discriminator network is complete, the flow may proceed to 614. Otherwise, flow may proceed back to 602, where another webpage image may be received. The training cycle for the discriminator network 132 may be determined to be complete based on any suitable criteria, such as, for example, the discriminator network 132 being trained for a set period of time, or being trained with a set number of webpage images from the training data set 162.

At 616, a random input may be received at a generator network. For example, the generator network 134 of the GAN 130 may receive a random input, which may be, for example, a feature vector generated with randomized elements.

At 618, an image may be generated with the generator network. For example, the generator network 134 may generate an image based on the random input. The image may be output from the generator network 134 in any suitable format, including, for example, as a feature vector that may be suitable for input to the discriminator network 132.

At 620, the image may be received at the discriminator network. For example, the image output by the generator network 134 may be input to the discriminator network 132.

At 622, a score level indicator may be generated with the discriminator network. For example, the discriminator network 132 may generate a score level indicator based on the image from the generator network 134 input to the discriminator network 132. The score level indicator may be, for example, a binary indicator, and may be an estimate of whether the image was, or would be, assigned a high score or not a high score by the heuristic scorer 120.

At 624, if the score level indicator is an estimate of a high score, flow may proceed to 630. Otherwise, flow may proceed to 626. If the score level indicator is an estimate of a high score, the image output by the generator network 134 may have been estimated, by the discriminator network 134, to be a webpage image that would receive a high score from the heuristic scorer 120, so no adjustment to the generator network 134 may be necessary. Otherwise, the generator network 134 may need to be adjusted.

At 626, adjustments may be determined for the generator network. For example, the generator trainer 138 may determine adjustments to be made to the generator network 134 based on the score level indicator output by the discriminator network 132 indicating an estimate of not a high score for the image that was output by the generator network 134. The adjustments may be, for example, adjustments to the weights of the generator network 134, and may be determined to minimize a loss function for the generator network 134.

At 628, adjustments may be applied to the generator network. For example, the generator trainer 138 may apply the determined adjustments the generator network 134. For example, the generator trainer 138 may apply the determined adjustments through backpropagation.

At 630, if the training cycle for the generator network is complete, the flow may proceed to 632. Otherwise, flow may proceed back to 616, where another random input may be received. The training cycle for the generator network 134 may be determined to be complete based on any suitable criteria, such as, for example, the generator network 134 being trained for a set period of time, or generating a set number of images that are input to the discriminator network 132.

At 632, if the training cycle for the GAN is complete, the flow may proceed to 634. Otherwise, flow may proceed back to 602, where another webpage image may be received and another training cycle for the discriminator network 132 may be started. The training cycle for the GAN 130 may be determined to be complete based on any suitable criteria, such as, for example, the completion of a set number of training cycles of both the discriminator network 132 and the generator network 134, or the achievement of both a threshold level of accuracy by the discriminator network 132 and a threshold percentage of images output by the generator network 134 being estimated by the discriminator network 132 to be images of webpages that were, or would be, assigned high scores by the heuristic scorer 120.

At 634, training may end. For example, the GAN 130 may be considered trained.

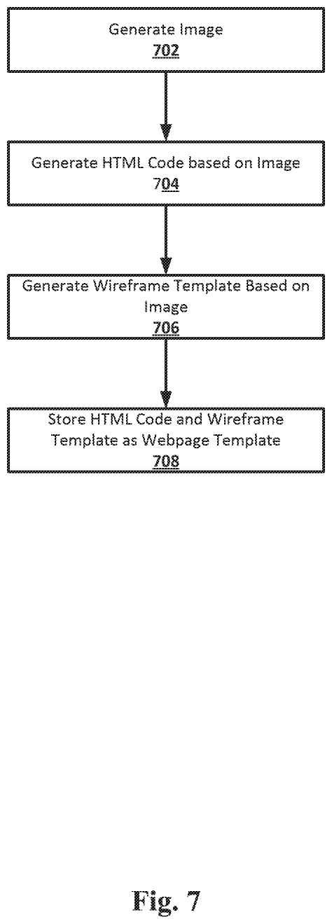

FIG. 7 shows an example procedure suitable for webpage template generation according to an implementation of the disclosed subject matter. At 704, an image may be generated. For example, the GAN 130 may generate an image. The image may be generated in any suitable format. The image may be generated by, for example, inputting a random input to the generator network 132 of the GAN 130. The generator network 134 may output the image the discriminator network 132, which may generate a score level indicator for the image. If the score level indicator is an estimate that the image is of a webpage that has been, or would be, assigned a high score by the heuristic scorer 120, the image may be output from the GAN 130.

At 704, HTML code may be generated based on the image. For example, the image, or a wireframe template generated from the image, may be input to the HTML generator 140. The HTML generator 140 may generate HTML code that may be used to render a webpage that may appear to be based on the image.

At 706, a wireframe template may be generated based on the image. For example, the image, or HTML code generated from the image, may be input to the wireframe generator 150. The wireframe generator 150 may generate a wireframe template, which may be, for example, a wireframe based on edges in the image from the GAN 130. The wireframe template may be output in any suitable format, such as, for example, in a vector format.

At 708, the HTML code and wireframe template may be stored as a webpage template. For example, the HTML code and the wireframe template generated based on the image from the GAN 130 may be stored as a webpage template for the image from the GAN 130 with the webpage templates 164. The webpage template for an image may be used to generate webpages that have the appearance of the image.

Implementations of the presently disclosed subject matter may be implemented in and used with a variety of component and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
generating scores for images of webpages;
training a generative adversarial network using the images of the webpages and the scores generated for the images of the webpages; and
generating one or more images using the trained generative adversarial network.

2. The computer-implemented method of claim 1, wherein training the generative adversarial network further comprises:
generating a score level indication for one of the images of webpages with a discriminator network of the generative adversarial network, wherein the discriminator network comprises a neural network;
determining that the score level indication is incorrect based on the score for the one of the images of webpages; and
based on the determination that the score level indication is incorrect, adjusting the neural network of the discriminator network.

3. The computer-implemented method of claim 1, wherein training the generative adversarial network further comprises:
generating an image with a generator network of the generative adversarial network, wherein the generator network comprises a neural network;
generating a score level indication for the image generated by the generator network with a discriminator network of the generative adversarial network;
determining that the score level indicator does not indicate an estimate of a high score for the image generated by the generator network; and
based on the determination that the score level indication does not indicate an estimate of a high score, adjusting the neural network of the generator network.

4. The computer-implemented method of claim 1, further comprising generating HTML code from an image of the one or more images generated using the trained generative adversarial network.

5. The computer-implemented method of claim 1, further comprising generating a wireframe template from an image of the one or more images generated using the trained generative adversarial network.

6. The computer-implemented method of claim 1, further comprising generating a webpage template from an image of the one or more images generated using the trained generative adversarial network, wherein the webpage template comprises one or both of HTML code and a wireframe template.

7. The computer-implemented method of claim 1, wherein the images of webpages comprise images of webpages from the same website.

8. The computer-implemented method of claim 1, wherein generating scores for the images of webpages comprises applying heuristics to the images of webpages.

9. A computer-implemented system for webpage template generation comprising:
one or more storage devices; and
a processor that generates scores for images of webpages, trains a generative adversarial network using the images of the webpages and the scores generated for the images of the webpages, and generates one or more images using the trained generative adversarial network.

10. The computer-implemented system of claim 9, wherein the processor trains the generative adversarial network by generating a score level indication for one of the images of webpages with a discriminator network of the generative adversarial network, wherein the discriminator network comprises a neural network, determining that the score level indication is incorrect based on the score for the one of the images of webpages, and based on the determination that the score level indication is incorrect, adjusting the neural network of the discriminator network.

11. The computer-implemented system of claim 9, wherein the processor trains the generative adversarial network by generating an image with a generator network of the generative adversarial network, wherein the generator network comprises a neural network, generating a score level indication for the image generated by the generator network with a discriminator network of the generative adversarial network, determining that the score level indicator does not indicate an estimate of a high score for the image generated by the generator network, and based on the determination that the score level indication does not indicate an estimate of a high score, adjusting the neural network of the generator network.

12. The computer-implemented system of claim 9, wherein the processor further generates HTML code from an image of the one or more images generated using the trained generative adversarial network.

13. The computer-implemented system of claim 9, wherein the processor further generates a wireframe template from an image of the one or more images generated using the trained generative adversarial network.

14. The computer-implemented system of claim 9, wherein the processor further generates a webpage template from an image of the one or more images generated using the trained generative adversarial network, wherein the webpage template comprises one or both of HTML code and a wireframe template.

15. The computer-implemented system of claim 9, wherein the images of webpages comprise images of webpages from the same website.

16. The computer-implemented system of claim 9, wherein the processor generates scores for the images of webpages by applying heuristics to the images of webpages.

17. A system comprising: one or more computers and one or more storage devices storing instructions which are operable, when executed by the one or more computers, to cause the one or more computers to perform operations comprising:
generating scores for images of webpages;
training a generative adversarial network using the images of the webpages and the scores generated for the images of the webpages; and
generating one or more images using the trained generative adversarial network.

18. The system of claim 17, wherein the instructions that cause the one or more computers to perform operations comprising training a generative adversarial network further cause the one or more computers to perform operations further comprising:
generating a score level indication for one of the images of webpages with a discriminator network of the generative adversarial network, wherein the discriminator network comprises a neural network;
determining that the score level indication is incorrect based on the score for the one of the images of webpages; and
based on the determination that the score level indication is incorrect, adjusting the neural network of the discriminator network.

19. The system of claim 17, wherein the instructions that cause the one or more computers to perform operations comprising training a generative adversarial network further cause the one or more computers to perform operations further comprising:
generating an image with a generator network of the generative adversarial network, wherein the generator network comprises a neural network;
generating a score level indication for the image generated by the generator network with a discriminator network of the generative adversarial network;
determining that the score level indicator does not indicate an estimate of a high score for the image generated by the generator network; and
based on the determination that the score level indication does not indicate an estimate of a high score, adjusting the neural network of the generator network.

20. The system of claim 17, wherein the instructions further cause the one or more computers to perform operations further comprising generating a webpage template from an image of the one or more images generated using the trained generative adversarial network, wherein the webpage template comprises one or both of HTML code and a wireframe template.
